(19) United States
(12) Patent Application Publication
(10) Pub. No.: US 2005/0276308 A1
(43) Pub. Date: Dec. 15, 2005

(54) Method and apparatus for measuring temperature and emissivity

(76) Inventor: Charles Steven Pint, Evanston, IL (US)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 10/865,322

(22) Filed: Jun. 10, 2004

(51) Int. Cl. G01J 5/00

(52) U.S. Cl. 374/121; 374/128

(57) ABSTRACT

Apparatuses for measuring temperature and emissivity, and methods of measuring temperature and emissivity are disclosed wherein the apparatus may include a processor adapted to execute an algorithm to adjust emissivity values until a desired temperature calculation is achieved. Accordingly, tedious manual adjustment steps by an operator are unnecessary.

### FIELD OF THE DISCLOSURE

The disclosure generally relates to methods of non-contact temperature measurement and, more particularly, relates to a method for determining an emissivity value of an object.

### BACKGROUND OF THE DISCLOSURE

Non-contact temperature instruments allow a user to ascertain the temperature of an object at a distance and are quick to respond. These operating features are particularly helpful when measuring the temperature of an object in a harsh or dangerous environment where physical contact is not an option. Such instruments generally operate by sensing the energy emitted from objects at a temperature above absolute zero in which the radiant infrared energy emitted by the object is proportional to the fourth power of its temperature.

Accuracy of the measured temperature is particularly dependant upon knowing the emissivity of the object. An object may absorb energy, transmit energy, and reflect energy. The law of conservation of energy dictates that the sum of coefficients for absorption, transmission, and reflection add up to 1. However, most objects are opaque, thus removing the transmission coefficient. Additionally, the absorptivity is synonymous with emissivity and is a measure of the ratio of thermal radiation emitted by an object to that of a blackbody. Generally speaking, emissivity is the ability of an object to absorb or emit energy. Blackbodies are perfect emitters and have an emissivity value of 1. An object with, for example, an emissivity of 0.75 will absorb 75% of the incident energy and reflect the remaining 25% (assuming no transmission). An infrared sensor senses energy from all three coefficients (absorption, transmission, and reflection) and, thus, must be calibrated to ignore all energy sources except for absorption, i.e., emissivity.

Users of such non-contact temperature instruments must typically input an emissivity value manually before operating the instrument. The instrument typically has a display area showing both the emissivity setting, temperature, and various adjustment buttons/switches. Tables are commonly available which state the emissivity for various materials at specific temperatures and under ideal conditions. Unfortunately, conditions may not be ideal due to the object having surface dust, oil films, and atmospheric particulate causing erroneous temperature measurements based on an “ideal” emissivity value.

Alternately, users may empirically determine an accurate emissivity value for the instrument by first measuring the surface temperature of the object with a contact-type temperature probe (e.g., thermocouple). While simultaneously viewing the temperature on the display, the user adjusts the emissivity setting until the temperature reading on the instrument display matches that of the contact-type temperature probe. At this point, the instrument may accurately measure the temperature for that specific material in similar environmental conditions.

While this process effectively allows the user to determine and set the emissivity, this process is tedious and requires numerous key strokes to make the proper adjustment. Furthermore, market demands require physically smaller instruments that do not allow the luxury of displays large enough to simultaneously show temperature, emissivity, and adjustment buttons/switches. The size limitations allow only a temperature display with some status indicators.

It would, therefore, be advantageous to set the emissivity for a non-contact temperature instrument automatically, which minimizes or eliminates manual data input by a user.

### SUMMARY OF THE DISCLOSURE

In accordance with one aspect of the disclosure, a method of measuring emissivity of a target is disclosed which may comprise inputting a first temperature and receiving data from a detector, the data indicative of the target temperature. The method may also comprise setting an initial emissivity value, setting an initial emissivity step size, setting a threshold, and calculating a second temperature based on the data and the emissivity value. The method may calculate a difference between the second temperature and the first temperature and compare the difference to the threshold. Additionally, the method may adjust the emissivity value if the second temperature surpasses the threshold, the emissivity value adjusted by the emissivity step size, and the second temperature recalculated using the adjusted emissivity value. Furthermore, the method may comprise saving the emissivity value if the second temperature is within the threshold.

In accordance with another aspect of the disclosure, an apparatus for measuring temperature is disclosed which may comprise a controller having a processor, an input and a memory. The input and the memory may be operatively coupled to the processor, the input receiving a first temperature value and saving it to the memory. The apparatus may also comprise a temperature sensing device, the temperature sensing device providing data to the processor, the processor selecting an emissivity value, the processor further calculating a second temperature using the data and the emissivity value. The apparatus for measuring temperature may also comprise the processor calculating a difference between the first temperature value and the second temperature, the processor comparing the difference against a threshold, the processor automatically adjusting the emissivity value if the threshold is exceeded, and the processor automatically saving the emissivity value to the memory if the threshold is not exceeded.

These and other aspects and features of the disclosure will become more readily apparent upon reading the following detailed disclosure when taken in conjunction with the accompanying drawings.

### BRIEF DESCRIPTION OF THE DRAWINGS

FIG. 1 is a block diagram of one embodiment of an apparatus for measuring temperature and emissivity in accordance with the teachings of the disclosure;

FIG. 2 is a flow chart representative of one embodiment of a method for measuring temperature and emissivity in accordance with the teachings of the disclosure.

While the disclosure is susceptible to various modifications and alternative constructions, certain illustrative embodiments thereof are shown in the drawings and will be described below in detail. It should be understood, however, that there is no intention to limit the disclosure to the specific embodiments disclosed, but on the contrary, the intention is to cover all modifications, alternative constructions, and equivalents falling within the spirit and scope of the disclosure as defined by the appended claims.

### DETAILED DESCRIPTION

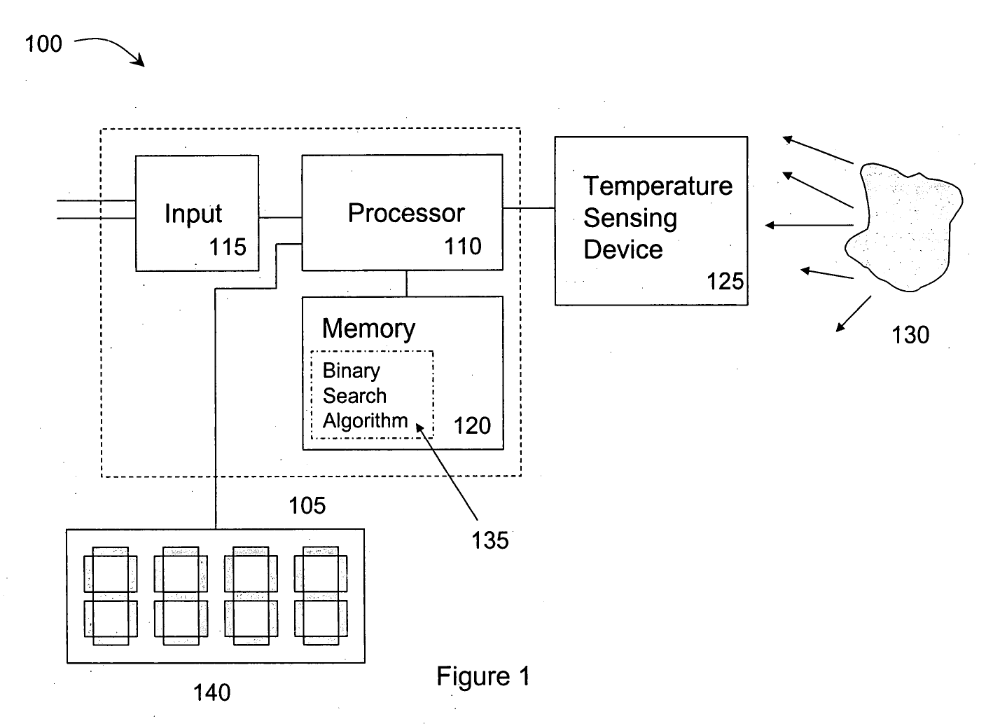

Referring now to the drawings, and with specific reference to FIG. 1, an apparatus for measuring temperature constructed in accordance with the teachings of the disclosure is generally referred to by reference numeral 100. While the apparatus 100 can be used to measure the temperature of many objects, examples include, but are not limited to metal, glass, ceramics, and plastic.

FIG. 1 shows the apparatus for measuring temperature 100 in block diagram format. A controller 105 comprises a processor 110 in which the processor 110 is operatively coupled to an input 115 and a memory 120. The processor 110 is further coupled to a temperature sensing device 125 which may comprise a detector sensitive to infrared radiation. The detector converts the infrared radiation energy from an object 130 to an electrical signal where the magnitude of that signal is used to calculate temperature.

As stated earlier, however, an accurate temperature calculation requires an appropriate emissivity value. Calculation of the appropriate emissivity value requires not only the signal from the temperature sensing device 125, but also a desired target temperature set point. The target temperature set point is entered via the input 115 and saved in the memory 120. Target temperature set point values may be entered manually by an operator via any known computer interface such as a keyboard, or optionally, by a computer, another controller, programmable logic controller (PLC), PDA, wired, or wireless signal. Further detail regarding calculation of the appropriate emissivity value will be discussed herein, however, the memory 120 also stores various algorithms, such as a binary search algorithm 135, which can be used in that calculation. Optionally, the apparatus may have an output 140 comprised of a character display (as shown in FIG. 1). Alternatively, the apparatus 100 may simply produce an output signal for industry standard devices, including LCD screens, computers, PLC's, and PDA's.

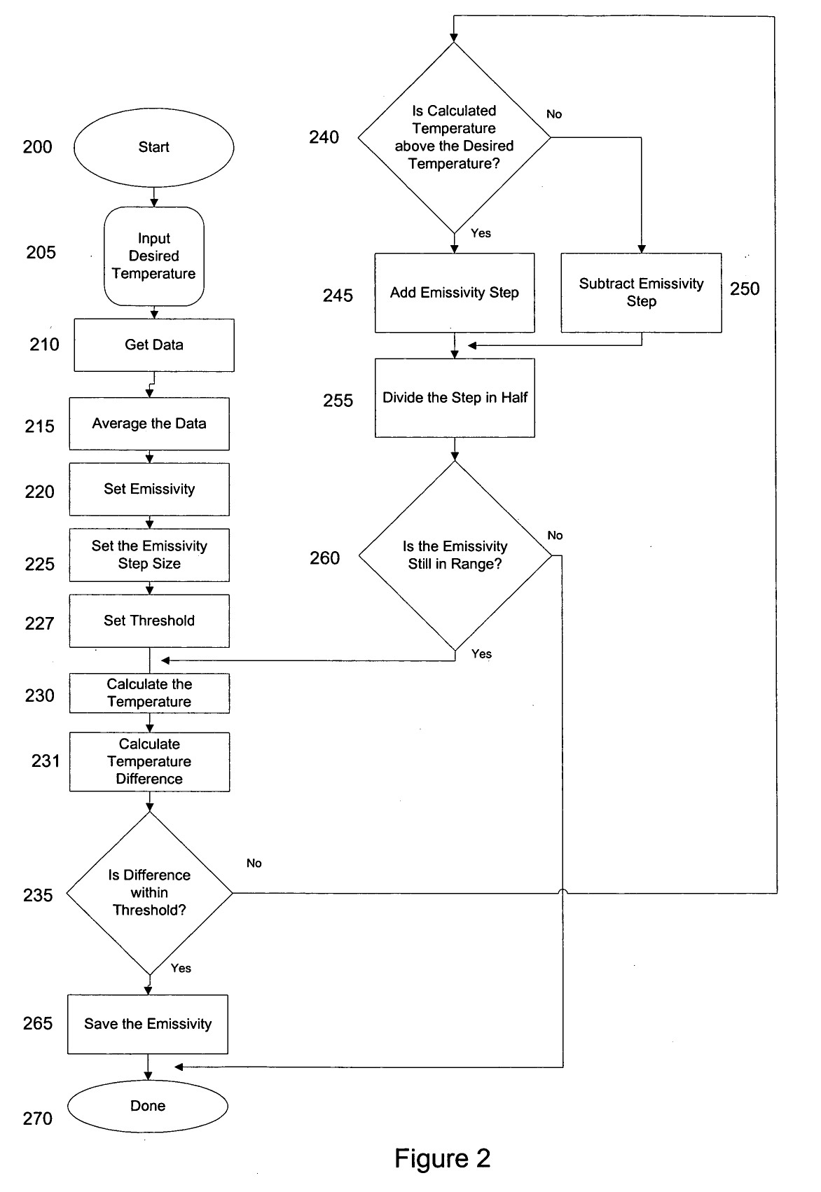

FIG. 2 shows a general flowchart of a method for measuring temperature in accordance with the teachings of the disclosure. The method may begin at 200 in which step 205 accepts a desired temperature input of an object. This temperature is typically obtained in a more traditional contact-type measurement, such as a bulb thermometer, resistance temperature detector (RTD), thermocouple (TC), or similar. Assuming that the object maintains the same temperature throughout this process, this input only needs to occur once as the temperature input data is saved to the memory 120. The input can come from an operator manually entering the desired temperature, or alternatively, entered as part of an automated process.

Step 210 acquires one or more samples of data from the temperature sensing device 125. The duration or number of data samples acquired may be a user-selectable parameter. Step 215 averages the data acquired at step 210 and saves it to memory 120 for later calculation. An emissivity starting point is set at step 220 that may simply be a mid-point of 0.5, or closer to a “ball-park” set point based on some knowledge of the emissivity of the object under test. For example, if the user knows the object 130 is an oxidized iron material around 100° C., then an emissivity of approximately 0.74 might be appropriate. Other materials would, of course, have other emissivity values generally ranging from 0.01 to 1.0. Again, the emissivity starting point parameter, as well as the emissivity step size (step 225), may be user-selectable. Additionally, emissivity upper and lower boundaries may also be user-selectable.

An initial temperature calculation occurs at step 230 using the emissivity starting point and the data acquired from the temperature sensing device 125. The processor 110 calculates a difference between the calculated temperature and the desired temperature at step 231 and then determines if the difference is within the threshold at step 235. If not, which is typically the case for a first iteration, the processor 110 determines if the calculated temperature is above or below the desired temperature at step 240. If the calculated temperature is above the desired temperature, then the emissivity value stored in the memory 120 increases by the step size at step 245. On the other hand, if the calculated temperature is below the desired temperature, then the emissivity value stored in the memory 120 decreases by the step size at step 250. In the event that an additional iteration is necessary, the step size divides in half at step 255. Step 260 verifies the finite boundaries of the emissivity and, if exceeded, the process stops at step 270. If not exceeded, another temperature calculation occurs at step 230 with the new emissivity value. Steps 230 through 260 may repeat as many times as necessary before either calculating a temperature within the threshold, or exceeding an emissivity boundary. The reader is encouraged to note that these steps illustrate a simple binary search, but other convergent numerical methods are possible.

Upon calculating a temperature that falls within the threshold, the emissivity value is saved at step 265 and the apparatus for measuring temperature 100 is configured to make repeated measurements of similar objects. This method is particularly useful in assembly lines where similar parts require temperature measurement quickly and without physical contact with a temperature measuring instrument.

While the aforementioned disclosure presents a method and apparatus employing a temperature sensing device dependant upon emissivity, the method and apparatus applies equally to a temperature sensing device employing multiple infrared wavelengths to determine temperature in which an appropriate E-Slope must be determined. The resulting temperature reading is based on the ratio of the intensities of the two signals that most objects attenuate equally. This eliminates a dependency on the emissivity of the object if each wavelength attenuates in the same way. Frequently, this multi-wavelength approach occurs when the measured object is in a dusty, moist, and smoke filled area. Therefore, if both signals propagate through such a medium, they attenuate equally, resulting in a constant ratio. Unfortunately, not all objects have the same emissivity at different wavelengths, resulting in inconsistent attenuation levels when simultaneously measuring both signals. Such objects are known as “non-greybodies” and create an unbalanced ratio. A biasing ratio, earlier stated as the E-Slope, allows correction of this phenomenon and this E-Slope utilizes the same method as shown in FIG. 2.

The foregoing description of temperature measurement devices, methods of measuring temperature and determining emissivity and E-Slope values have been set forth merely to illustrate the disclosure and are not intended to be limiting. Because modifications of the disclosed embodiments incorporating the spirit and substance of the disclosure may occur to persons skilled in the art, the disclosure should be construed to include everything within the scope of the claims to be presented and equivalents thereof.

1. A method of measuring emissivity of a target, comprising:
inputting a first temperature;
receiving data from a detector, the data indicative of the target temperature;
setting an initial emissivity value;
setting an emissivity step size;
setting a threshold;
calculating a second temperature based on the data and the emissivity value;
calculating a difference between the second temperature and the first temperature;
comparing the difference to the threshold;
adjusting the emissivity value if the second temperature surpasses the threshold, the emissivity value adjusted by the emissivity step size, the second temperature recalculated using the adjusted emissivity value; and
saving the emissivity value if the second temperature is within the threshold.

2. The method of claim 1, wherein the adjusting of the emissivity value and the temperature recalculation repeat until the second temperature is within the threshold.

3. The method of claim 2, wherein the repeating stops if the emissivity value exceeds a pre-determined boundary.

4. The method of claim 1, further including dividing the step size in half.

5. The method of claim 1, further including receiving a plurality of data from the detector, the plurality of data averaged for a time period.

6. The method of claim 1, further including receiving a plurality of data from the detector, the plurality of data averaged for a pre-determined number of data points.

7. The method of claim 1, wherein the initial emissivity value is 0.5.

8. The method of claim 1, wherein the emissivity value is increased by the step size if the second temperature is higher than the first temperature.

9. The method of claim 8, wherein the emissivity value is checked against an upper threshold.

10. The method of claim 9, wherein the upper threshold is 1.0.

11. The method of claim 1, wherein the emissivity value is decreased by the step size if the second temperature is lower than the first temperature.

12. The method of claim 11, wherein the emissivity value is checked against a lower threshold.

13. The method of claim 12, wherein the lower threshold is 0.01.

14. The method of claim 1, wherein the emissivity value is adjusted using an algorithm.

15. The method of claim 14, wherein the algorithm is a binary search algorithm.

16. The method of claim 1, wherein the detector is an infrared detector.

17. The method of claim 16, wherein the detector measures a single wavelength.

18. The method of claim 16, wherein the detector measures multiple wavelengths.

19. An apparatus for measuring temperature, comprising:
a controller comprising a processor, an input and a memory, the input and the memory operatively coupled to the processor, the input receiving a first temperature value and saving it to the memory; and
a temperature sensing device, the temperature sensing device providing data to the processor,
the processor selecting an emissivity value, the processor further calculating a second temperature using the data and the emissivity value,
the processor calculating a difference between the first temperature value and the second temperature,
the processor comparing the difference against a threshold,
the processor automatically adjusting the emissivity value if the threshold is exceeded;
the processor automatically saving the emissivity value to the memory if the threshold is not exceeded.

20. The apparatus of claim 19, wherein the temperature sensing device is an infrared detector.

21. The apparatus of claim 20, wherein the infrared detector measures a single wavelength.

22. The apparatus of claim 20, wherein the infrared detector measures multiple wavelengths.

23. The apparatus of claim 19, wherein the processor repeatedly calculates the second temperature, calculates the difference between the first temperature value and the second temperature, compares the difference against the threshold, and automatically adjusts the emissivity value until the threshold is not exceeded.

24. The apparatus of claim 19, wherein the processor stops adjusting the emissivity value if a predetermined emissivity value threshold is exceeded.

25. The apparatus of claim 19, further including an algorithm to automatically adjust the emissivity value.

26. The apparatus of claim 25, wherein the algorithm is a binary search algorithm.

27. The apparatus of claim 19, wherein the controller is a programmable logic controller.

28. A method of measuring E-Slope of a target, comprising:
inputting a first temperature;
receiving data from a detector, the data indicative of the target temperature;
setting an initial E-Slope value;
setting an E-Slope step size;
setting a threshold;
calculating a second temperature based on the data and the E-Slope value;
calculating a difference between the second temperature and the first temperature;
comparing the difference to the threshold;
adjusting the E-Slope value if the second temperature surpasses the threshold, the E-Slope value adjusted by the E-Slope step size, the second temperature recalculated using the adjusted E-Slope value; and
saving the E-Slope value if the second temperature is within the threshold.

29. The method of claim 28, wherein the adjusting of the E-Slope value and the temperature recalculation repeat until the second temperature is within the threshold.

30. The method of claim 29, wherein the repeating stops if the E-Slope value exceeds a pre-determined boundary.

31. The method of claim 28, further including dividing the step size in half.

32. The method of claim 28, further including receiving a plurality of data from the detector, the plurality of data averaged for a time period.

33. The method of claim 28, further including receiving a plurality of data from the detector, the plurality of data averaged for a pre-determined number of data points.

34. The method of claim 28, wherein the initial E-Slope value is 1.0.

35. The method of claim 28, wherein the E-Slope value is increased by the step size if the second temperature is higher than the first temperature.

36. The method of claim 35, wherein the E-Slope value is checked against an upper threshold.

37. The method of claim 36, wherein the upper threshold is 1.2.

38. The method of claim 28, wherein the E-Slope value is decreased by the step size if the second temperature is lower than the first temperature.

39. The method of claim 38, wherein the E-Slope value is checked against a lower threshold.

40. The method of claim 39, wherein the lower threshold is 0.80.

41. The method of claim 28, wherein the E-Slope value is adjusted using an algorithm.

42. The method of claim 41, wherein the algorithm is a binary search algorithm.

43. The method of claim 28, wherein the detector is an infrared detector.

44. The method of claim 43, wherein the detector measures multiple wavelengths.

45. An apparatus for measuring temperature, comprising:
a controller comprising a processor, an input and a memory, the input and the memory operatively coupled to the processor, the input receiving a first temperature value and saving it to the memory; and
a temperature sensing device, the temperature sensing device providing data to the processor,
the processor selecting an E-Slope value, the processor further calculating a second temperature using the data and the E-Slope value,
the processor calculating a difference between the first temperature value and the second temperature,
the processor comparing the difference against a threshold,
the processor automatically adjusting the E-Slope value if the threshold is exceeded;
the processor automatically saving the E-Slope value to the memory if the threshold is not exceeded.

46. The apparatus of claim 45, wherein the temperature sensing device is an infrared detector.

47. The apparatus of claim 46, wherein the infrared detector measures multiple wavelengths.

48. The apparatus of claim 45, wherein the processor repeatedly calculates the second temperature, calculates the difference between the first temperature value and the second temperature, compares the difference against the threshold, and automatically adjusts the E-Slope value until the threshold is not exceeded.

49. The apparatus of claim 45, wherein the processor stops adjusting the E-Slope value if a pre-determined E-Slope value threshold is exceeded.

50. The apparatus of claim 45, further including an algorithm to automatically adjust the E-Slope value.

51. The apparatus of claim 50, wherein the algorithm is a binary search algorithm.

52. The apparatus of claim 45, wherein the controller is a programmable logic controller.
